(19) United States
(12) Patent Application Publication
(10) Pub. No.: US 2005/0259033 A1
(43) Pub. Date: Nov. 24, 2005

(54) Multiplex-selective heads-up displays for cars

(76) Inventor: Alfred B. Levine, Bethesda, MD (US)

Correspondence Address: ALFRED B. LEVINE, P.O. BOX 34-IT.38, BETHESDA, MD, 20827, US

(21) Appl. No.: 10/986,927

(22) Filed: Nov. 15, 2004

Related U.S. Application Data
(60) Provisional application No. 60/572,487, filed on May 20, 2004.

(51) Int. Cl. G09G 5/00

(52) U.S. Cl. 345/7

(57) ABSTRACT

Safety systems and methods for driver operated motor vehicles. The systems and methods respond to adverse weather to regulate traffic flow of vehicles, and to change the performance of vehicles in more than two different modes of operation. The systems and methods further locate other vehicles ahead and at the sides of said vehicle, and communicate such locations and proximity of the other vehicles, as well as warning the driver of the danger of collision. The information provided by such systems and methods is communicated to the vehicle driver in such manner that the driver's vision and attention are not diverted away from other traffic conditions ahead of the vehicle.

### STATEMENT OF INVENTION

This invention generally relates to heads-up displays and warnings for driver operated vehicles, and more particularly to such systems for communicating a number of different conditions concerning the vehicle and other vehicles, as well as roadway conditions affecting the safety of driving the vehicle.

### BACKGROUND

Driving of motor vehicles has become increasingly dangerous due to higher speeds of travel and steadily increasing numbers of vehicles on the roads. Drivers experience constant risk from other drivers that are reckless, inattentive, careless, incapacitated, or impatient as well as from adverse weather conditions. It is therefore necessary for driving safety that drivers remain alert and constantly attentive to road conditions, particularly those ahead of their proceeding vehicle. It is has also become increasingly necessary that drivers receive more information about prevailing road conditions and about other vehicles in the vicinity of their vehicle.

### SUMMARY OF THE INVENTION

According to the invention there is provided a comprehensive system for detecting a number of different conditions affecting the safety of the vehicle and its driver, and communicating such conditions to the driver in such manner that the driver's attention and observations are not diverted away from concentration on the road and vehicular traffic ahead of the vehicle. Among others the system provides information concerning the operation of the vehicle itself as well as that of nearby vehicles; prevailing weather conditions; as well as traffic regulations and temporarily changed traffic conditions. In addition, the system provides warning to the driver when various of the detected conditions raise the danger of a collision or crash with other vehicles or objects. Driver's are informed of the safe stopping distance of their vehicle at all different speeds and different weather conditions. Drivers are informed of the location and distances of other vehicles ahead and at the sides and rear of the vehicle, without the need for consulting the side and rearview mirrors. When nearby vehicles are too close, or otherwise in danger of collision, the drivers are warned of the dangers. Where weather conditions are adverse to safe travel and reasonable travel speeds, the roadside traffic signs are changed to promote safer driving, and the drivers are notified of the changed traffic restrictions within their vehicles. Adverse weather conditions are also detected and used to change the acceleration-speed performance of the vehicles in more than two modes of operation for safer driving, and the drivers are informed of the changed performances. All of the information and warnings are presented to the drivers inside of the vehicle and in such manner as to permit the driver's attention to be continually focused on the road ahead of the vehicle and with minimized diversion of the driver's attention to safe driving of the vehicle.

### BRIEF DESCRIPTION OF THE DRAWINGS

FIG. 1 is a block diagram showing computation and display of the vehicle minimum stopping distance,

FIG. 2 is a block diagram showing collision warning and display of the time remaining before collision,

FIG. 3 is a block diagram showing determination of a driver's reaction time for response,

FIG. 4 is a block diagram showing a system for changing road sign traffic regulations according to the severity of adverse weather conditions,

FIG. 5 is a block diagram showing the reading, display, and recording of changeable roadside traffic signs within the vehicle,

FIG. 6 is a view of an onboard pictoral display within the vehicle showing other nearby vehicles and objects, and their locations, and warnings, according to the invention,

FIG. 7 is a block diagram showing a detection and display system for producing the display of FIG. 6,

FIG. 8 is a graphical representation showing three different performance modes of operation for control of a vehicle,

FIG. 9 is a block diagram showing a system for controlling the vehicle in the three performance modes represented in FIG. 8, responsively to adverse weather according to the invention,

FIG. 10 is a block diagram, similar to FIG. 9, but showing manual control of the different performance modes of vehicle operation according to the invention,

### DETAILED DESCRIPTION OF PREFERRED EMBODIMENTS

Minimum Safe Stopping Distance

Multiple collisions between serial chains of vehicles on highways often occur during periods of bad weather or when one of the vehicles unexpectedly stops or slows and the other vehicles are too close together to permit stopping in time to avoid the multiple sequential collisions. Drivers are frequently not aware of the distances required to stop their vehicles at different speeds and under different conditions of bad weather. According to the invention there is provided a system for continually calculating such minimum safe stopping distances and displaying these distances to the driver.

Referring to FIG. 1 for one preferred embodiment, the system employs a vehicle speed sensor 10, and a road condition sensor 11 for detecting the vehicle traction with the road (e.g. degree of ice or slippery roadway). These sensor signals are applied to a vehicle processor 15. The processor 15 is also energized with a fixed signal 12 corresponding to the stopping characteristics of the particular vehicle (manufacturers design), and a variable signal 13 corresponding to the degree of brake wear and tire wear. The brake and tire wear signal is approximated from the vehicle odometer mileage, and this wear signal is connected to be reset when new tires and/or new brakes are added to the vehicle. The minimum safe stopping distance for the vehicle is also controlled by the driver's delay or “reaction time” in applying the brakes, since the slower the driver's “reaction time “the longer distance results in stopping of the vehicle.

All of these signals are applied to processor 15 to calculate the minimum distance required to stop the vehicle, and this calculated distance is applied to a visual display 16 for communication to the vehicle driver.

Thus the system continually calculates a different minimum safe stopping distance for the vehicle at each different speed and under different detected weather conditions that affect the traction of the vehicle tires with the roadway. Thus the driver is continually informed of a minimum distance that should be allowed between his vehicle and any one ahead (vehicle or obstacle) to insure the driver's ability to stop the vehicle under unexpected or emergency conditions.

Since many drivers are unable to accurately estimate highway distances, the invention further detects the actual distance to a vehicle ahead, communicates such distance to the driver, and warns the driver when the distance to a leading vehicle ahead is less than the minimum safe stopping distance of the driver's vehicle.

Referring again to FIG. 1, the system further includes a sonic or ultrasonic radar, radio radar unit 17, or Lidar unit (laser) that detects the actual distance to a leading vehicle ahead, and sends such actual distance signal to a comparator 18. The comparator 18 is also energized by the minimum safe stopping distance signal obtained from the processor 15, as discussed above. Where the actual distance ahead to a leading vehicle is less than the computed safe stopping distance for the driver's vehicle, the comparator circuit 18 energizes an audible warning device 19 within the vehicle to alert the driver that his vehicle is too close to the one ahead to permit his vehicle to stop if necessary to avoid a collision.

Collision Warning Time

Where the driver's vehicle is approaching a vehicle ahead at a greater speed than the vehicle ahead, there is a danger of a collision if the greater speeding of the driver's vehicle is not slowed down before reaching the leading vehicle. According to the invention, the system further determines this dangerous condition and calculated the time that such a collision might occur.

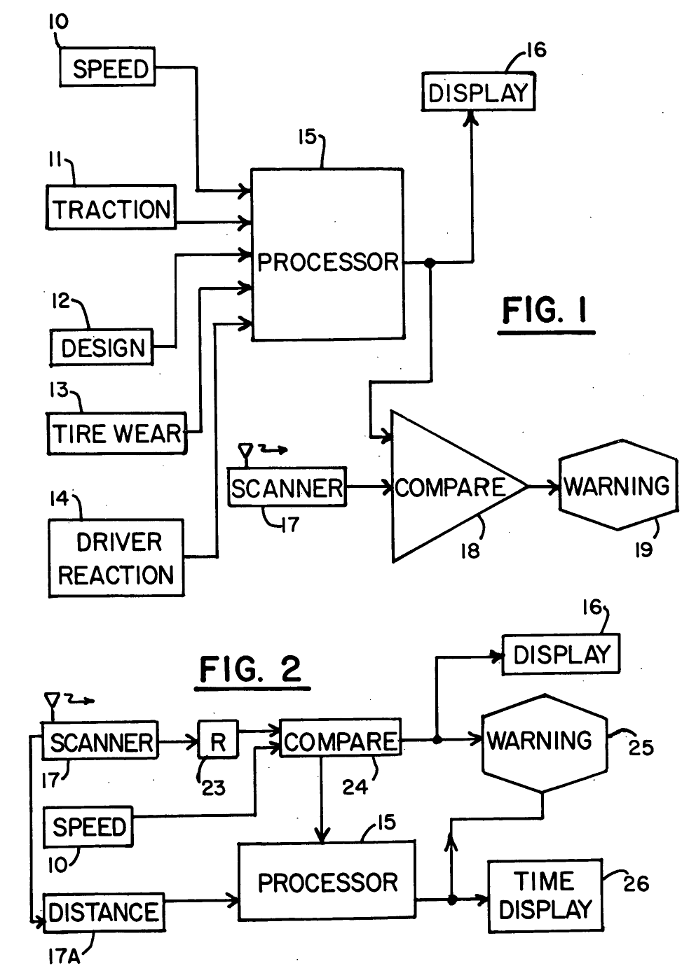

Referring to FIG. 2, the signal from the sonic or radio or laser radar scanner 17 is applied to a rate defining circuit 23 to determine the rate of speed of the vehicle ahead (eg Doppler). This speed signal is applied to a comparator 24 where it is compared to the speed of the driver's vehicle. The actual distance signal between the two vehicles is obtained from radar scanner 17, and the difference speed signal from comparator 24 and this distance signals from 17 are applied to the processor 15 to calculate the expected time of collision (distance divided by speed difference). The expected time of collision signal is applied to a visual display 26 within the vehicle to warn the driver of the potential emergency of collision and when it might occurin time.

Briefly recapitulating the functioning of FIG. 1 and FIG. 2, the system continually computes and displays the minimum stopping distances for the vehicle taking into account the different speeds of the vehicle and the different weather conditions that affect the ability of the vehicle to stop. The system also responds to the delay or “reaction time” of the driver as well as the design characteristics of the vehicle, and also responds to the wear of the brakes and tires. In addition the system determines the actual distance between the vehicles, and warns if the vehicles are proceeding too closely together whereby the trailing vehicle would be unable to stop in an emergency to avoid a collision. Still further, the system determines the relatively different speeds of the two vehicles and computes the time when a collision might occur in the event that the trailing vehicle is proceeding at a greater speed than the leading vehicle.

Driver Reaction Time

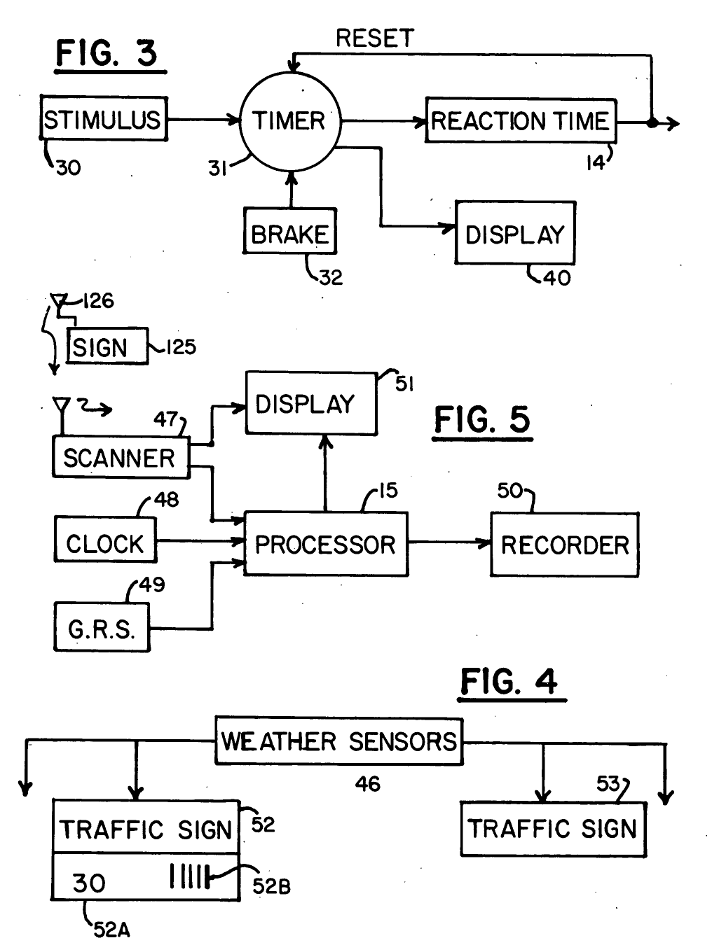

According to the invention, the” reaction time” of drivers is obtained when the vehicle is located at standstill using the system shown in FIG. 3.

Referring to FIG. 3, the testing system comprises a stimulus generator 30 for briefly generating a visible message to the driver, such as “apply brakes”. Concurrently with the message, the generator 30 activates a timer 31 to start running and accumulate a time period. When the driver responds and applies the vehicle brakes, a signal from the brake 32 energizes the timer 31 to stop. The accumulated time delay between the generation of the stimulus (visual message) and the driver's response by applying the brakes corresponds to the driver's “reaction time”. This time delay signal is applied to generator 14 that energizes the processor 15 (FIG. 1) to calculate the minimum stopping distance.

Weather Controlled Traffic Regulation

Traffic control along roads is customarily performed using road-side traffic signs that establish maximum speed limits and other fixed regulations governing the flow of vehicles. However such fixed speed limits and other fixed content regulations are not safe for travel during periods of bad weather conditions when the roads may be iced, or very slippery during heavy rainstorms or snowstorms. Similarly during periods of fog and poor visibility, drivers must also exercise greater caution and drive more slowly and carefully. During such dangerous weather conditions, drivers should more slowly accelerate and more gradually stop (decelerate), and should always maintain a greater distance to a vehicle ahead. Unfortunately many driver's do not heed the greater danger of travel during such bad weather conditions and proceed in the same manner as they do during good weather conditions when the roads are dry and provide better traction to permit faster accelerating and stopping.

The preferred embodiment shown in FIG. 4 provides for adjustable traffic regulation of vehicles according to the severity of the ambient weather conditions affecting the vehicles, including the road condition (eg tire traction), and the driver's vision of the road. As shown, the roadside traffic signs 52, 53, . . . are adjustably changed in content by weather detecting sensors 46 to provide stricter traffic regulations according to the degree of defected adverse weather conditions. The weather sensors 46 detect ice, sleet, rain, snow, windstorm, fog, flooding, and other adverse conditions, affecting the safe driving of vehicles.

According to the invention, the road signs 52,53 . . . , display the weather changeable traffic regulations in two different forms; comprising an alpha-numeric displayed number 52a, or words, that are optically readable by the drivers of passing vehicles. In the second displayed form, the signs 52,53 . . . display a bar code 52b, or other machine readable form, that is readable by scanners 47 (FIG. 5) within passing vehicles.

The weather detecting sensors 46 may be incorporated within the road signs themselves 52,53 . . . , or located externally of said signs 52,53 . . . . The weather detecting sensors 46 may alternatively be located remotely of the signs 52,53 . . . , such as at the locations of the Traffic authorities, with control signals being remotey transmitted to said signs 52,53 . . . either by wired or wireless connections to change the content of the signs according to the severity of the detected adverse weather conditions.

As shown in FIG. 5 there is provided within passing vehicles bar code scanners 47 to read the changed content of the passing road signs 52, 53 . . . , and display their contents within the vehicle on a heads-up vehicle visual display 51. The code scanners 47 direct the sign content readings to the vehicle processor 15 where they are, in turn, recorded in a vehicle BLACK BOX recorder 50. Since the road sign regulations are made changeable according to the adverse weather conditions, it is necessary to maintain a record of such readings for later enforcement of traffic regulations, if necessary. To identify the time, date, and location of any changed traffic sign, the vehicles are also provided with a date and time clock 48, and with a GPS receiver 49. Signals from the the clock 48, and the GPS receiver 49 are recorded in the vehicle BLACK BOX recorder 50 along with each of the changed traffic sign readings received from the bar code scanners 47.

Briefly recapitulating the above, traffic flow is adjustably regulated according to adverse weather conditions by employing changeable traffic road signs 52, 53 . . . whose regulations are changed according to the severity of detected bad weather conditions. The changed contents of the road signs are visually read by drivers of passing vehicles. Additionally, the road signs 52,53 include a machine readable code 52b displaying their changed content. The sign codes 52b are remotely read by bar code scanners 47 within the passing vehicles. A record is maintained of the changed content of the road signs by recording the bar code readings in a BLACK BOX recorder 50 within the vehicles. The vehicle location for each of the changed road signs is also recorded in the vehicle BLACK BOXE from a GPS receiver 49 along with the date and time of the changed content of the road signs by an onboard vehicle clock 48.

Omnidirectional Vehicle Display

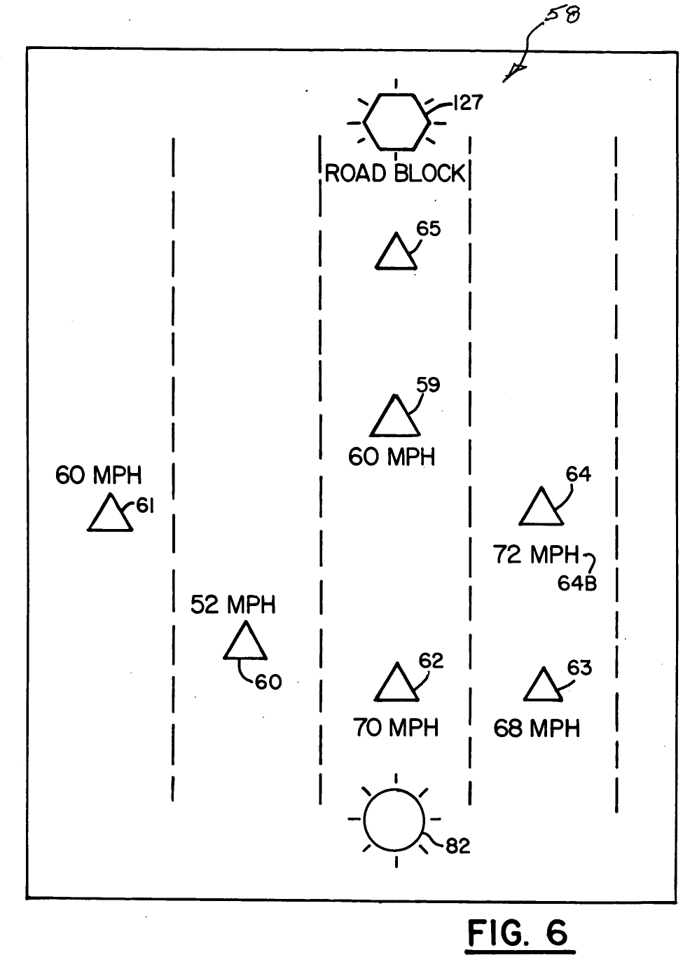

FIG. 6 illustrates a pictoral display system 58 located within a vehicle for continually displaying icons of the driver's vehicle 59 together with the locations of all surrounding vehicles 60 to 65, inclusive, that are near the driver's vehicle on the sides, front, and rear thereof. In addition to showing the locations, the relative distances of the other vehicles from the driver's vehicle 59 are shown. The display also shows the speed of each of the other vehicles 60 to 65, inclusive, as well as the distances that such other vehicles are located from the driver's vehicle 59. In a preferred embodiment, the display of FIG. 6 is presented in a heads-up form before the driver. Thus the driver can view the display 58 and continually note all of the surrounding vehicles 60 to 65, inclusive, as well as their locations and speeds referenced to that of the driver's vehicle 59.

In this preferred embodiment, the display 58 of FIG. 6 is presented in semi-transparent form on the inside front windshield of the vehicle and directly in the front view of the driver. Thus the driver can observe all of the surrounding vehicles omnidirectionally around his vehicle without diverting his vision from the road ahead of his vehicle. It is therefore unnecessary for the driver to periodically divert attention from the road to view his side view mirrors, or his rear view mirror, to keep track of surrounding vehicles. The omnidirectional display of the present invention also provides the driver with a view of the “blind spots” or areas around the vehicle that can not be seen using the side view and rear view mirrors.

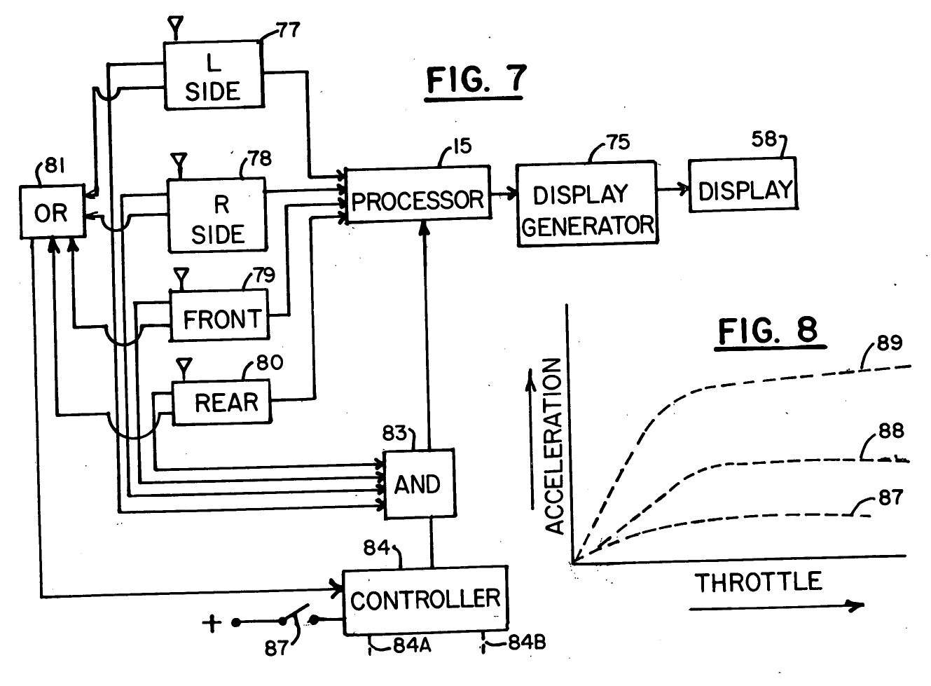

FIG. 7 shows a preferred system for obtaining and processing the information presented in the display of FIG. 6. As shown, the vehicle is provided with scanning sensors 77, 78, 79, and 80 to observe the left side, right side, front, and rear of the vehicle.

Each of these scanning sensors comprises a digital transmit-receive unit of conventional kind (eg radio, sonic, or laser) that directs pulses outwardly in different directions toward such other vehicles and receive reflections from such vehicles. As known, the direction of each scanner when receiving the pulse reflections corresponds to the relative location of the targeted vehicle, and the transit time of receiving the reflected pulses corresponds to the distance of the targeted vehicle from that of the driver's vehicle. Each of these sensors 77 to 80 includes a rate detector to detect the Doppler shift in in phase and frequency of the reflected pulses, and these rate signals are applied to the vehicle processor 15 to calculate the speed of each one of the targeted other vehicles 60 to 65, reapectively. The signals from the vehicle processor 15 are applied to a display generator 75 that generates the display 58 of FIG. 6 and projects this display on the inside of the front windshield of the vehicle.

Thus the projected pictoral display 58 of FIG. 6 is obtained by using onboard scanning sensors 77 to 80 to observe other vehicles that are omnidirectionally located around the driver's vehicle; and the locations, distances, and speeds of each of the detected vehicles is obtained and processed from the sensor signals to generate the graphic display 58 of FIG. 6 that is presented to the driver in Heads-up display form.

According to the invention, a number of different displays and warnings are visually presented to the driver to assist in safe driving of the vehicle. These different displays may be concurrently presented in heads-up form, side by side, on the vehicle windshield. Alternatively, the different displays may be presented individually, or in selected groups. These different individual displays, or subgroups of displays, may be individually selected for display by the vehicle driver (using manual switches or the like, not shown) or may be automatically activated in response to given movements of the vehicle, or in response to actions taken by the driver.

For example, the omnidirectional traffic display of FIG. 6 may not be continuously presented until it is activated by the driver (by manual switch control) or automatically activate when the vehicle driver begins to, or signals to turn the vehicle into a different traffic lane. Referring to FIG. 7, the sign as from the scanning sensors 77 to 80 may be instead directed to an AND circuit 83 rather then being applied directly to the vehicle processor 15. The AND circuit 83 being, in turn, controlled by an event responsive controller 84 that responds to either the driver's operation of the conventional vehicle turn signal lever 84a, 84b, or responds to the vehicle beginning to make a turn into a different lane. Upon either event occurring, energization of the AND circuit 83 applies the signals from scanners 77 to 80, to the processor 15 to automatically activate the display 58 of FIG. 6 within the vehicle. The omnidirectional display 58 of FIG. 6 may also be manually activated by the driver closing a switch 87. Still further, the omnidirectional display of FIG. 6 may be automatically activated when any of the other vehicles is detected by the scanners 77 to 80 to approach too closely to the driver's vehicle 59. When such a dangerous condition occurs, the detecting signals from that one of the scanners 77 to 80, is directed through OR circuit 8 [symbol] to energize the controller 84 resulting in activation of the omnidirectional display 58. Additionally, the activating signal that is generated whenever a nearby vehicle is too close to the driver's vehicle can be applied to the display generator 75 from the processor 15 to operate a flashing light 82 in the display 58 (FIG. 6) near the other vehicle that is too close, thereby further alerting and warning the vehicle driver of the dangerous condition.

Tri-Mode Vehicle Performance

The high performance of contemporary vehicles creates many dangers in bad weather. Rapid engine acceleration in response to throttle advances during periods of poor road traction often results in skidding, fishtailing, and loss of vehicle control. During periods of deep fog, heavy rain and snow fall, rapid acceleration often results in crashes and collisions because of the driver's failure to observe other vehicles or objects in time to slow down and avert such obstacles. According to the present invention, there is provided a system for changing the acceleration-throttle response of vehicles in at least three multiple modes of operation according to the severity of bad weather conditions thereby to more safely drive and control automotive vehicles.

FIG. 8 graphically illustrates three different modes of control of the acceleration-throttle performance of a vehicle according to the invention. As shown, the lowest performance mode 87 is selected to most severely control and limit the acceleration of the vehicle in response to application of the throttle during periods of severely bad weather with poor road traction resulting from icing, and/or very intense fog, rainfall, or snowfall. Advancing the throttle in this mode 87 very slowly increases the vehicle acceleration as is required for safer driving during such bad weather. In the second performance mode 88, the vehicle response is improved, permitting acceleration more rapidly with throttle advance during periods of less severe weather when the roads may be moderately slippery, and/or the driver's vision only partially obscured by less intense fog, rain, snow, or sleet. In the third performance mode 89 that is selected during good weather with substantially dry roads and clear weather conditions, the acceleration-throttle response of the vehicle is permitted to perform according to the optimum design performance of the vehicle. Other performance modes for controlling the vehicle performance may also be employed to respond to adverse weaher conditions, as will be appreciated by those skilled in the art.

Thus the present invention controls different ranges of vehicle-throttle-acceleration performance depending upon the severity of the bad weather conditions for safer operation of the vehicle. In the most severe weather, with poor or very poor road traction and poor or very poor driver vision of the road, the system restricts the acceleration of the engine with throttle advance to a lowest level, thereby reducing the possibility of vehicle skidding, fishtailing or otherwise loss of control and better enabling the vehicle to slow or stop if needed. Where the weather condition is not as bad but still offers less than optimal road traction or driver's visibility, a different performance mode of acceleration-throttle response is controlled thereby to permit better operation of the vehicle of the vehicle (performance) than in the lowest mode but still providing some acceleration restraint for safety under the less than optimal weather conditions. In the best performance mode 89 that functions in in good or moderately good weather with dry roads, the vehicle acceleration-throttle performance is unrestricted and the vehicle is permitted to accelerate with advances of the throttle according to the optimum design performance of the vehicle.

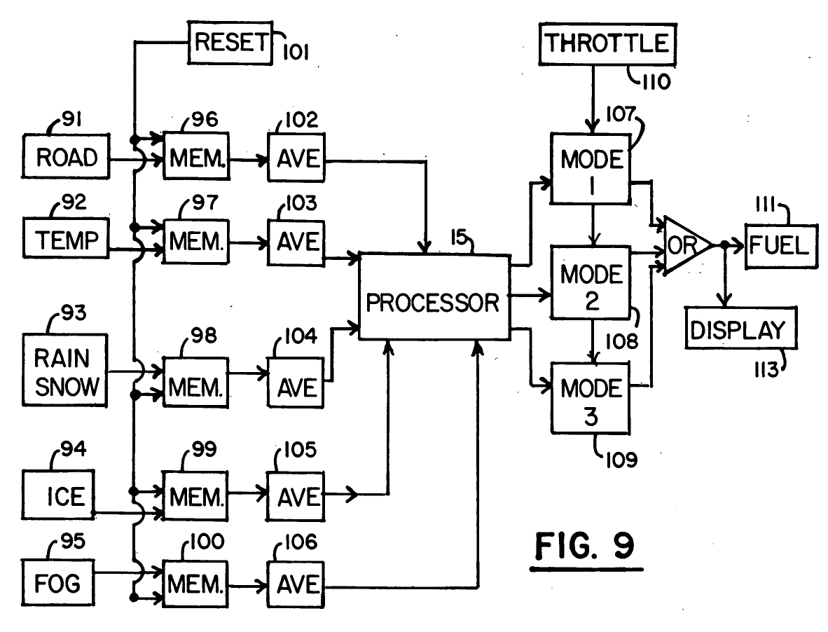

FIG. 9 illustrates a preferred control system for controlling the different acceleration-throttle performance modes shown in FIG. 8 according to the different weather conditions discussed above. As shown, the system includes a series of sensors 91 to 95, inclusive for detecting the various weather conditions, including a road traction sensor 91; an outside temperature sensor 92; a rain-snow detecting sensor 93; an ice detecting sensor 94; and a fog detecting sensor 95. Each of these sensors 91 to 95 directs its output to a related memory 96 to 100, respectively, as shown, where each of the sensor readings are stored for a short time period until the memories are periodically reset by a timer 101. The readings from each of these memories 96 to 100 inclusive, are periodically retained in the averaging circuits 102 to 106, respectively, and thence passed to the vehicle onboard processor 15.

In the processors, the plural detected weather conditions (from sensors 91 to 95) are analyzed to determine the severity of the weather conditions, using known algorithms of fuzzy logic or other. The vehicle onboard processor 15 determines the degree of severity of the weather condition and actuates a different one of the mode controlling digital circuits 107, 108, or 109 to control the acceleration-throttle performance of the vehicle, in the manner discussed above. The mode control circuits 107, 108, and 109 are preferably non-linear digital function generators to generate the acceleration-throttle waveform curves shown in FIG. 8. Each of these digital controlling circuits 107, 108, and 109 responds to the driver's advance of the vehicle throttle 110 to generate its control signal to regulate the vehicle fuel valve 111, and braking (as needed).

Thus the onboard processor 15 automatically selects the different mode of controlled operation of the vehicle (performance) according to the severity of the detected weather condition, and the vehicle acceleration response to the driver's operation of the throttle is regulated by the function generated by the selected one of the mode control circuits 107, 108, or 109. Thus when the ambient weather condition is degraded with very poor road traction, the processor 15 selects the most restrictive performance mode controller 107 to regulate the fuel control valve 111 for to restrict the vehicle acceleration-throttle performance to its lowest level as depicted in curve 87 of FIG. 8. Where the weather condition is not as adverse, the second mode control generator 108 is selected by the processor 15 to provide lesser restriction of the vehicle acceleration-throttle performance according to the curve 88 in FIG. 8. And where the detected weather is better, or good, the function generator 109 is selected by the processor 15 to provide unrestricted acceleration-throttle response of the vehicle as shown by curve 89 in FIG. 8.

In an alternative embodiment, the driver of the vehicle can manually select the different performance modes of the vehicle according to the driver's perception of the degree of bad weather.

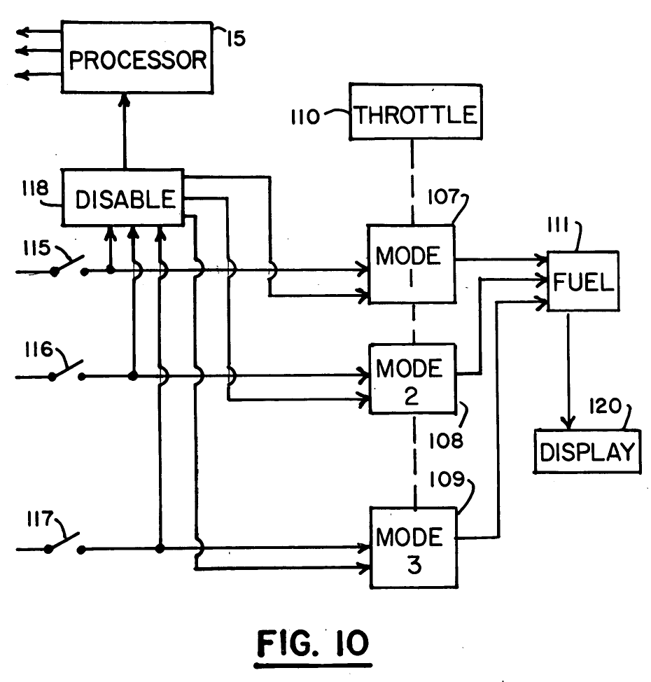

Referring to FIG. 10 for a consideration of this alternative manual selection, the vehicle is provided with a series of manually operated switches 115, 116, and 117, with a different one of these manual switches being connected for selecting each of the different mode controllers 107, 108, or 109, respectively, as shown. When the vehicle driver manually closes any one of the switches 115, 116, or 117, the corresponding one of the mode generators 107, 108, or 109 is energized and the remaining ones of these manual switches are disabled from operation. As described above, the selected mode controller energizes the fuel control valve 111 according to the advance of the throttle and according to the function provided by that controller, to regulate the performance of the vehicle. Closure of any one of the manual switches 115, 116, or 117 also sends a signal to disable circuit 118 to disconnect the processor 15 from automatically selecting any one of the remaining ones of mode generators 1067 108, or 109. Thus upon manually closing any of the manual control switches 115, 116, or 117, the driver can select a different one of the different performance modes for the vehicle according to the driver's perception of the severity of the weather. Upon making such manual selection, the driver also disables the automatic selection of vehicle performance by the vehicle processor 15.

### Disable Vehicle or Object Detection and Warning

Stopped or disabled vehicles, or other objects, on or near the road lanes present an unexpected hazard to drivers, particularly at the higher speeds of present traffic flow. The present invention alerts and warns the drivers of such hazards before such hazards are reached or viewed from approaching vehicles.

Referring again to FIG. 5, portable traffic control signs 125 as well as all road repair-service vehicles, and passenger vehicles and trucks not shown) are provided with an emergency wireless warning transmitter 126 for transmitting a fixed frequency wireless warning signal whenever such portable signs, or vehicles or other obstacles are stopped on or near a road traffic lane. Scanning sensors 47 aboard vehicles approaching such objects receive such wireless warning signal sufficiently in advance of reaching such road sign 125 or other oobject to permit the driver to slow or stop his approaching vehicle as may be necessary. The received warning signal from the vehicle scanning sensor 47 is applied to the vehicle processor 15, as shown, to energize the vehicle visual display 51. The vehicle scanning sensor 47 thereby alerts the driver of the presence of the stopped vehicle or object ahead before the driver's vehicle reaches it. The location of the stopped vehicle or object is shown on the vehicle display 51.

Alternatively, a different digital code may be transmitted as a warning signal to identify each of different types of objects stopped along the roadway, whereby the vehicle processor 15 can determine from the received warning code, the type of obstacle located in the road ahead, and can generate an icon representing such identified type of obstacle in the vehicle display 51 (FIG. 6).

Thus drivers of approaching vehicles are warned in advance of the presence of unexpected traffic control signs 125 carried by police, road repair crews, and others in the road ahead, as well as stopped or disabled vehicles that may present a hazard to approaching traffic. Since the road blocking objects may be unexpectantly encountered, the display 51 may further show the blockage as a flashing light 127 (FIG. 6). Where warning code transmissions are used to identify the type of object blocking the road ahead, or the presence of portable traffic control signs 125, the vehicle display 58 (FIG. 6) may also display an icon of the identified object.

Many changes may be made in the embodiments described above without departing from the invention. The heads-up displays may be presented elsewhere in the vehicle at a location that permits observation by the driver without materially diverting attention from safe driving of the vehicle. Additional information about the vehicle, other vehicles, and outside traffic conditions may be included in the visual displays presented to the driver. Warnings may be given by the displays in the form of flashing lights, icons, or in other ways to alert the driver of dangers. Such warnings can be accompanied by audible warnings, or audible warnings may replace some of the visual warnings. Detected weather conditions that are sensed by the weather sensors can be displayed to inform or alert the driver to conditions such as slippery roads and poor road traction. Where the vehicle performance is changed or modified in response to adverse weather conditions, the displays may show such reduced performance. The driver “reaction delay time” may be obtained in alternative manners using audible instructions to trigger a response by the driver. Since these and other changes may be made within the invention, this invention should be considered as being limited only by the following claims.

1. A heads-up display system for a driver operated vehicle comprising:
Speed responsive means within the vehicle for continually determining the minimum safe stopping distance for the vehicle at all speeds,
Collision warning means within the vehicle for determining when the distance of the vehicle from an external object is less than said minimum safe stopping distance,
Sign reading sensor means within the vehicle for remotely reading weather changeable traffic control road signs,
Object detecting sensor means within the vehicle for detecting the presence of other vehicles near said vehicle and determining the locations of said detected other vehicles,
Vehicle proximity warning means within the vehicle for determining when such other vehicles are sufficiently near said vehicle present a danger of collision with said vehicle,
Multiple range performance control means for said vehicle for changing the performance of said vehicle responsively to bad external weather conditions,
Said speed responsive means, collision warning means, sign reading sensor means, object detecting means proximity warning means, and multiple performance control means all energizing said heads-up display system within the vehicle for displaying to the driver the functioning and operation of said means in such manner as to not divert the driver's attention away from safe driving of the vehicle.

2. In the heads-up display system of claim 1,
Said object detecting and locating system being normally disabled from said heads-up display system and responsive to the beginning of a turning of said vehicle to activate a heads-up display of other nearby vehicles and their locations.

3. A heads-up display system for a driver operated vehicle, said system comprising:
sensor means for detecting the speed of the vehicle and detecting the tractive condition of the road being traveled by the vehicle,
processor means responsive to said sensor means for determining the minimum stopping distance for the vehicle at the sensed speed and tractive condition of the road,
and a head-up display for the vehicle energized by the processor for displaying the minimum stopping distance to said driver without materially diverting the driver's observation of the road ahead of the vehicle.

4. In the system of claim 3,
said sensor means additionally detecting the forward distance of a vehicle ahead of the driver operated vehicle,
said processor comparing said forward distance with said minimum stopping distance and generating a warning signal when said minimum stopping distance exceeds said forward distance.

5. In the system of claim 3,
Said sensor means detecting the rate of approach of the driver operated vehicle to said vehicle ahead, and energizing said processor means,
And said processor means calculating the time period for a collision to occur between the driver operated vehicle and the vehicle ahead based upon the continuation of said rate of approach, and energizing said heads-up display to display said time period to the driver of the driver operated vehicle.

6. A system for calculating the minimum stopping distance for a driver operated vehicle for different speeds of the vehicle and for different traction conditions of the road over which the vehicle is traveling comprising:
sensor means for detecting the speed of the vehicle and detecting the tractive condition of the road being traveled by the vehicle,
a processor responsive to said sensor means for calculating the minimum stopping distance based upon said speed and road tractive condition,
and a display for said vehicle for presenting said minimum stopping distance to the driver of said vehicle, thereby to inform the driver of the minimum distance to proceed behind a vehicle ahead.

7. In claim 3,
said vehicle having manually operated brakes to stop the vehicle,
The addition of means for determining the reaction time of the driver's response to an unexpected event,
Said processor means responsive to said reaction time to modify the calculated minimum safe stopping distance.

8. In claim 6,
The addition of means for detecting the distance ahead to a leading vehicle,
Comparing means for comparing the detected distance to the leading vehicle with the calculated minimum stopping distance for the vehicle,
And alarm means for warning the driver when the detected distance is less than the calculated distance.

9. In claim 6,
The addition of means for detecting the distance from said vehicle to a leading vehicle ahead of said vehicle and the relative speeds of said vehicle compared to the speed of the vehicle ahead,
And computing means for determining the period remaining for a collision with said leading vehicle in the event that said vehicle is proceeding at a speed greater than that of the vehicle ahead.

10. A method for traffic regulation of driver operated vehicles, comprising the steps of:
Providing a series of adjustable content traffic signs spaced apart along a roadway,
Detecting the adversity of weather conditions affecting vehicles traversing said roadway,
Adjusting the content of said traffic regulation signs according to the detected adversity of said weather conditions to provide a changed content,
Remotely reading the changed content of said traffic regulation signs from vehicles traversing the roadway,
And displaying the changed content of said read traffic regulation signs within the vehicle in such manner as to not materially divert the driver's attention away from safe operation of the vehicle.

11. In the method of claim 10,
The additional step of recording the content of the changed traffic regulation signs within the vehicle, thereby permitting the changed content of the signs to be reproduced within the vehicle at a later time.

12. In the method of claim 10,
The additional steps of detecting the location of the changed traffic regulation signs and the time of the changed content,
And recording the location and time together with the changed content of the road regulation signs, thereby permitting the changed content of the road regulation signs to be reproduced within the vehicle at a later time along with their location and the time the changed content was remotely read.

13. In a driver operated motor driven vehicle,
Visual display means for showing the presence and proximity of other vehicles near the sides of said vehicle,
Said visual display means comprising a pictoral display of said other vehicles being presented within the vehicle in such manner as to present a minimized diversion of the driver's attention away from attention to driving,
Sensor means for detecting said other vehicles, said sensor means energizing said visual display means,
Said visual display means being normally inactive to display, and being responsive to a beginning of a vehicle turn to present said display to the driver.

14. In claim 13,
Said vehicle having turn signals and manually operated turn signal controls,
And said visual display means being responsive to manual operation of said turn signal controls to activate said visual display.

15. In claim 13,
Said vehicle having manually operated steering controls operable by the driver,
And said visual display means being activated responsively to the beginning of turning of the vehicle by the driver's operation of the steering controls.

16. In a driver operated vehicle,
Sensors detecting the presence and locations of other nearby vehicles as the vehicle proceeds,
A display system within the vehicle for responsive to said sensors for presenting a pectoral image showing the presence and relative location of nearby vehicles with reference to the locations of said driver operated vehicle,
Said display system being normally inactive to display said image and being responsive to the beginning of one of a vehicle turning or vehicle lane changing or by operation of a turn signal by said driver to activate said display system to present said image.

17. In the system of claim 16,
Said sensor means detecting the relative speeds of said other vehicles referenced to that of said vehicle,
And calculating means energized by said sensor means for calculating the remaining time period that any of said other vehicles might collide with said vehicle.

18. In a driver operated vehicle powered by a motor in response to the manual application of a throttle by the driver [symbol]
Sensor means for detecting the degree of adverse ambient weather affecting the safe driving of the vehicle,
Multiple performance control means for said motor for changing the response of the motor to manual application of the throttle in more than two different modes of operation, thereby changing the acceleration-speed performance of the vehicle,
Said multiple performance control means being energized by said sensor means to proportionally lessen the acceleration-speed performance of the vehicle according to the degree of adversity of the detected ambient weather conditions.

19. In claim 18,
Manually operated means selectable by the driver to change said multiple performance control means thereby changing the mode of operation of the vehicle.

20. In a driver operated vehicle,
A system for providing a [symbol] nce warning of the presence of a stationary object in the road ahead of said vehicle,
Said object including one of a portable traffic control sign, a disabled vehicle, a stationary service vehicle, and a stationary hazard,
Said object having a wireless transmitter for transmitting a wireless signal to identify its presence,
And a detector for said vehicle for detecting said wireless signal when the vehicle is located at a distance remote from said object thereby to warn said driver of the object before the vehicle nears the object.

21. In a driver operated vehicle,
A heads-up display for visually presenting road and traffic information to the driver of the vehicle,
Said road and traffic information comprising one of the minimum safe stopping distance for the vehicle, or the time of a projected collision with nearby vehicles, or the presence and locations of nearby vehicles, or the content of changeable traffic sign regulations, or the different performance modes of operation of the vehicle, or the presence of stationary vehicles or objects on the road ahead of the vehicle,
Control means for selectively controlling said heads-up display for displaying any one of said road and traffic information individually or displaying any group of such road and traffic information concurrently in such manner as to minimize diverting the driver's attention from safe driving of the vehicle.

22. In claim 21,
said control means being manually operable by the driver to selecting the road and traffic information of interest for display.

23. In claim 21,
Said control means being automatically operable in response to vehicle changes, including turns into other traffic lanes.

24. In a driver operated motor vehicle, a system for changing traffic regulations responsive to bad weather conditions for safer driving of said vehicle,
Weather detecting sensors and control means for detecting adverse weather conditions affecting the vehicle,
Said weather detecting sensors and control means being applied to change the content of roadside traffic regulation signs according to the severity of the detected weather conditions,
Sign reader means within said vehicle for remotely reading the content of roadside traffic regulation signs when the vehicle is near said signs,
And display and recording means within said vehicle for displaying the content of said roadside traffic regulation signs that are read by said sign reader means and recording said content within said vehicle.

25. In claim 24,
Means within the vehicle for detecting the time and location of the vehicle when the sign reader means remotely reads the content of the roadside traffic signs, and recording the time and vehicle location together with the content of the roadside traffic signs
